(19) United States
(12) Patent Application Publication
(10) Pub. No.: US 2009/0252502 A1
(43) Pub. Date: Oct. 8, 2009

(54) METHODS AND SYSTEMS FOR OPTICAL COMMUNICATION

(75) Inventor: YANJUN ZHU, Santa Clara, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: FutureWei Technologies, Inc., Plano, TX (US)

(21) Appl. No.: 12/098,965

(22) Filed: Apr. 7, 2008

(51) Int. Cl. H04B 10/04

(52) U.S. Cl. 398/188; 398/182

(57) ABSTRACT

An optical communication system includes an optical carrier signal source that provides an optical carrier signal and one or more optical modulators coupled to the optical carrier signal source. The optical modulators modulate the optical carrier signal to produce a continuous wave optical signal in response to one or more input electrical signals. The system also includes a pulse modulator coupled to the optical modulators. The pulse modulator adaptively modulates the continuous wave optical signal to cause carrier energy suppression and nonlinearity reduction. In a specific embodiment, the pulse modulator modulates the continuous wave optical signal in response to al pulse signal, which is characterized by an amplitude and a bias point. At least one of the amplitude and the bias point being adaptively determined to cause carrier energy suppression and nonlinearity reduction. Additionally, the system can also include an optical spectral monitor for modulator bias stabilization.

### CROSS-REFERENCES TO RELATED APPLICATIONS

Not Applicable

### STATEMENT AS TO RIGHTS TO INVENTIONS MADE UNDER FEDERALLY SPONSORED RESEARCH OR DEVELOPMENT

Not Applicable

### REFERENCE TO A “SEQUENCE LISTING,” A TABLE, OR A COMPUTER PROGRAM LISTING APPENDIX SUBMITTED ON A COMPACT DISK

Not Applicable

### BACKGROUND OF THE INVENTION

The present invention is directed to optical communication. More particularly, the invention provides methods and system for modulating optical signals, which can deliver increased system nonlinear tolerance and optical signal-to-noise ratio (OSNR) tolerance for use in optical communication systems. Merely by way of example, the invention has been applied to Differential Quadrature Phase Shift Keying (DQPSK) modulation for optical signal transmission. But it would be recognized that the invention has a much broader range of applicability. For example, the invention can be used in high-speed dense wavelength division multiplexing (DWDM) optical transmission systems.

Recent optical transport systems are built on wavelength division multiplexing (WDM) transmission techniques. WDM systems with line rates of 10 Gbit/s have been deployed, and 40 Gbit/s systems are being actively introduced to carriers at present. More over, 100 Gbit/s transport is being considered. Various modulation formats have been applied, including On-Off-Keying (OOK) formats such as Non-Return-to-Zero (NRZ), Return-to-Zero (RZ), Optical Duobinary (ODB), etc., and Phase Shift Keying (PSK) formats such as Differential Phase Shift Keying (DPSK), and Differential Quadrature Phase Shift Keying (DQPSK), etc.

DQPSK, in particular RZ-DQPSK, is widely considered as one of the promising techniques for next generation 40 Gbit/s (NG-40G) transmission systems. Since DQPSK is based on the transmission of 2 bits/symbol, it gives either a doubled capacity when the baud rate is chosen to be the same as the line rate, or a reduced line rate if the baud rate is half the targeted line rate. Therefore, DQPSK systems are expected to benefit, to some extent, from the reduced line rate characteristic, when compared with traditional time division multiplexed (TDM) systems. For example, costs of components required to build a DQPSK system are reduced, and system tolerances such as chromatic dispersion (CD) tolerance and polarization mode dispersion (PMD) tolerance could be improved, as a result of the reduced line rate characteristic.

DQPSK is also referred to as NRZ-DQPSK. Other DQPSK formats can be generated, for example, by applying a pulse carving. To generate NRZ-DQPSK signals, there are generally three types of approaches, depending on what types of modulators are used. The first type is based on an integrated DQPSK modulator (Dual-parallel Mach-Zehnder Modulator Approach); the second type is based on multiple discrete modulators (Multiple Discrete Modulator Approach); and the third type is based on a single dual-drive modulator (Single Dual-Drive Modulator Approach).

Even though conventional optical signal modulation systems have found wide use, there are still limitations that can restrict the scope and performance of optical communication systems. These limitations include signal nonlinearity and system noise as discussed further below.

From the above, it is seen that an improved technique for optical signal modulation is desired.

### BRIEF SUMMARY OF THE INVENTION

The present invention is directed to optical communication. More particularly, the invention provides methods and system for modulating optical signals, which can deliver increased system nonlinear tolerance and optical signal-to-noise ratio (OSNR) tolerance for use in optical communication systems. Merely by way of example, the invention has been applied to Differential Quadrature Phase Shift Keying (DQPSK) modulation in conjunction with Modified-Carrier-Suppressed Return-To-Zero (mCSRZ) modulation. This combination forms a Modified-Carrier-Suppressed Return-To-Zero Differential Quadrature Phase Shift Keying (mCSRZ-DQPSK) optical modulator that can provide enhanced nonlinearity tolerance and reduced distortions in the optical signal. But it would be recognized that the invention has a much broader range of applicability. For example, the invention can be used in high-speed DWDM optical transmission systems.

According to a specific embodiment, the present invention provides an optical communication system. The system includes an optical carrier signal source that produces an optical carrier signal and one or more optical modulators coupled to the optical carrier signal source. The optical modulators modulate the optical carrier signal to produce a continuous wave optical signal in response to one or more input electrical signals. Additionally, the system includes a pulse modulator coupled to the optical modulators to receive the continuous wave optical signal. The pulse modulator is selectively configured to modulate the continuous wave optical signal to cause carrier energy suppression and nonlinearity reduction. In a specific embodiment, the pulse modulator modulates the continuous wave optical signal in response to a pulse signal, which is characterized by an amplitude and a bias point. At least one of the amplitude and the bias point is adaptively selected to cause carrier energy suppression and nonlinearity reduction. In an embodiment, both of the amplitude and the bias point are adaptively determined. Additionally, in a specific embodiment, the system also includes an optical spectral monitor for maintaining modulator bias stabilization.

In a specific embodiment, the pulse signal is an electrical pulse signal. Depending on the embodiment, various bias conditions can be used. In one example, the bias point of the electrical pulse signal is between a null point and a maximum point, but does not include the null point or the maximum point, of the continuous wave optical signal. In another example, the amplitude of the electrical pulse signal is selected such that the electrical pulse signal drives the pulse modulator through the null point. In yet another example, the electrical pulse signal is biased at a quadrature point and drives through the null point of the phase modulators to achieve enhanced carrier suppression. In an alternative example, the electrical pulse signal is biased at a non-quadrature point and has a predetermined amplitude, and an output optical signal is characterized by a flat top spectral profile. In another example, the electrical pulse signal is biased at a non-quadrature point and has a predetermined amplitude, and an output optical signal is characterized by a central dip spectral profile. In yet another example, the electrical pulse signal is biased at a non-quadrature point and has a predetermined amplitude, and an output optical signal is characterized by a broad bell-shaped spectral profile.

In a specific embodiment, the one or more phase modulators includes a first and a second phase modulators and produce an NRZ-DQPSK continuous wave optical signal, and the pulse modulator adaptively produces a mCSRZ-DQPSK. In another embodiment, the one or more phase modulators includes a first and a second phase modulators and produce an NRZ-DQPSK continuous wave optical signal. The pulse modulator adaptively produces a mCSRZ-DQPSK in response to an RF electrical pulse signal having a bias point at a quadrature point and an amplitude greater than Vπ, thereby causing enhanced carrier suppression by means of raising the RF power levels.

According to another specific embodiment, the invention provides an optical modulation system. The system includes a laser that produces an optical carrier signal, and a first and a second Mach-Zehnder modulators coupled to the laser. The Mach-Zehnder modulators modulate the optical carrier signal to produce a NRZ-DQPSK optical signal in response to one or more input electrical signals. The system also includes a pulse modulator coupled to the Mach-Zehnder modulators to receive the continuous wave optical signal. The pulse modulator adaptively modulates the NRZ-DQPSK optical signal in response to an electrical pulse signal. The electrical pulse signal is biased at a shifted non-quadrature biasing point and has a predetermined amplitude. In the system, the non-quadrature biasing point is adaptively determined to cause carrier energy suppression and nonlinearity reduction. In a specific embodiment, the system also includes a mini optical spectral analyzer (OSA) for maintaining modulator bias stabilization.

According to an alternative embodiment, the invention provides another optical modulation system. The system includes a laser that produces an optical carrier signal, and a first and a second Mach-Zehnder modulators coupled to the laser. The Mach-Zehnder modulators modulate the optical carrier signal to produce a NRZ-DQPSK optical signal in response to one or more input electrical signals. The system also includes a pulse modulator coupled to the Mach-Zehnder modulators to receive the continuous wave optical signal. The pulse modulator adaptively modulates the NRZ-DQPSK optical signal in response to an RF electrical pulse signal. In the system, the electrical pulse signal is biased at a quadrature biasing point and has an amplitude greater than Vπ of the Mach-Zehnder modulators. The amplitude is adaptively determined to cause carrier energy suppression and nonlinearity reduction.

According to an embodiment of the present invention, a method is provided for optical signal modulation. The method includes providing an optical carrier signal and modulating the optical carrier signal in response to one or more input electrical signals using one or more optical modulators to produce a continuous wave optical signal in response to one or more input electrical signals. The method also includes adaptively modulating the continuous wave optical signal to cause carrier energy suppression and nonlinearity reduction. In a specific embodiment, the method further includes providing an electrical pulse signal characterized by an amplitude and a bias point. At least one of the amplitude and the bias point is adaptively determined. Moreover, the method includes modulating the continuous wave optical signal in response to the electrical pulse signal to cause carrier energy suppression and nonlinearity reduction.

In a specific embodiment, the bias point of the electrical pulse signal is between a null point and a maximum point, but does not include the null point or the maximum point, of the continuous wave optical signal. In another embodiment, the amplitude of the electrical pulse signal is selected such that the electrical pulse signal drives the pulse modulator through the null point. In yet another embodiment, the electrical pulse signal is biased at a quadrature point and drives through the null point of the phase modulators to achieve enhanced carrier suppression.

The various bias conditions can lead to different output power spectrum characteristics. In one example, the electrical pulse signal is biased at a non-quadrature point and has a predetermined amplitude, and an output optical signal is characterized by a flat top spectral profile. In another example, the electrical pulse signal is biased at a non-quadrature point and has a predetermined amplitude, and an output optical signal is characterized by a central dip spectral profile. In yet another example, the electrical pulse signal is biased at a non-quadrature point and has a predetermined amplitude, and an output optical signal is characterized by a broad bell-shaped spectral profile. In an embodiment, the method also includes maintaining modulator bias stabilization using an optical spectral monitor.

Many benefits are achieved by way of the present invention over conventional techniques. For example, in an embodiment, the invention provides an optical modulation system and associated methods including an adaptive clock modulator and an optical signal modulator for enhanced nonlinear tolerances and improved OSNR performance. In a specific embodiment, the optical modulation system and method includes a modified CSRZ clock modulator and a DQPSK modulator.

In embodiments of the invention, techniques are provided for adaptive modulation for improved nonlinear tolerance and improved OSNR performance. In a specific embodiment, a method is provided for biasing the clock pulse in the clock modulator such that the clock pulse drives through null but is not biased at either the null or the peak for carrier energy suppression. In another embodiment, adaptive biasing method for the clock modulator uses a optical spectral analyzer (OSA). In an alternative embodiment, a clock modulator, e.g. a pulse carver, has fixed biasing and adaptive clock amplitude setting for enhanced nonlinear tolerances and improved OSNR performance.

Additionally, the various embodiments are compatible with conventional product technology without substantial modifications to conventional equipment and processes. Depending upon the embodiment, one or more of these benefits may be achieved. These and other benefits will be described in more detail throughout the present specification and more particularly below.

Various additional objects, features and advantages of the present invention can be more fully appreciated with reference to the detailed description and accompanying drawings that follow.

### BRIEF DESCRIPTION OF THE DRAWINGS

FIG. 1 is a simplified block diagram of an optical communication system according to an embodiment of the present invention;

FIG. 2 is a simplified block diagram illustrating an optical transmission system according to a specific embodiment of the present invention;

FIG. 3 is a simplified diagram showing one of the mechanisms of mCSRZ pulse generation based on a Mach-Zehnder modulator;

FIG. 4 is a simplified diagram showing the characteristic spectra of 40 Gbit/s (2×20 Gbaud) mCSRZ-DQPSK signals according to a specific embodiment of the present invention;

FIG. 5 shows a simplified block diagram of an mCSRZ-DQPSK optical system 500 according to another embodiment of the present invention.

FIG. 6 shows a simplified block diagram of an mCSRZ-DQPSK optical system 600 according to an alternative embodiment of the present invention;

FIG. 7 is a simplified diagram comparing the spectrum of a quadrature-biased mCSRZ-DQPSK with that of a non-quadrature-biased mCSRZ-DQPSK; and

FIGS. 8-11 show the results from experimental studies comparing the performances of an mCSRZ-DQPSK system according to an embodiment of the invention to those of a conventional RZ-DQPSK system.

### DETAILED DESCRIPTION OF THE INVENTION

The present invention is directed to optical communication. More particularly, the invention provides methods and system for modulating optical signals, which can deliver increased system nonlinear tolerance and optical signal-to-noise ratio (OSNR) tolerance for use in optical communication systems. Merely by way of example, the invention has been applied to Differential Quadrature Phase Shift Keying (DQPSK) modulation in conjunction with Modified-Carrier-Suppressed Return-To-Zero (mCSRZ) modulation. This combination forms a Modified-Carrier-Suppressed Return-To-Zero Differential Quadrature Phase Shift Keying (mCSRZ-DQPSK) optical modulator for optical communication systems. But it would be recognized that the invention has a much broader range of applicability. For example, the invention can be used in high-speed DWDM optical transmission systems.

As discussed above, conventional DQPSK modulation, though successful in certain applications, suffers from many limitations. Because there is a carrier phase difference of 90 degree between I-component and Q-component in DQPSK, strong nonlinear interactions (in particular, cross phase modulation) between the two exist. This aspect is easily noticeable in DQPSK transmission experiments.

Certain improvements may be achieved by using Carrier Suppressed Return-to-Zero DQPSK (CSRZ-DQPSK). CSRZ-DQPSK can be generated by using DQPSK with a CSRZ pulse carver. In an example, to generate a CSRZ pulse, a MZ modulator is driven with a 2Vπ sinusoidal RF signal. In conventional CSRZ-DQPSK systems, the RF signal is biased exactly at the null.

A conventional CSRZ-DQPSK was used by Y. Zhu et al in ‘1.6 bit/s/Hz orthogonally polarized CSRZ-DQPSK transmission of 8×40 Gbit/s over 320 km NDSF’, presented at Optical Fiber Communication Conference (OFC'2004), paper TuF1. The nonlinear advantage of CSRZ-DQPSK over NRZ-DQPSK for applications to high spectral efficiency system was shown by Y. Zhu et al, in the paper entitled ‘Highly spectrally efficient transmission using CSRZ-DQPSK’, presented at IEEE Workshop on Advanced Modulation Formats, San Francisco, June 2004.

Owing to the significant cross phase modulation effect between the I- and Q-component, the nonlinear impairments of a DQPSK signal can be much stronger than that of a TDM signal, even for a single optical wavelength. As a result, the application of DQPSK could be only suitable to very limited systems, where dispersion maps are carefully chosen and signal launch power tends to be very low, in order to avoid the nonlinear penalties. As a result, network deployments based on DQPSK and system operating margins can be limited. Hence there is a need to develop more nonlinear tolerant DQPSK modulation technique.

The nonlinearity tolerances of conventional NRZ-DQPSK, RZ-DQPSK and CSRZ-DQPSK are often not strong enough to ensure significant system margins, especially in systems strongly limited by XPM impairments, such as in systems with mixed transmission of 10G OOK and 40G DQPSK signals.

The frequency chirping in CRZ-DQPSK can help to improve the nonlinear tolerances of CRZ-DQPSK beyond those achievable by NRZ-DQPSK, RZ-DQPSK and CSRZ-DQPSK. However, the amount of chirp that can be applied is eventually limited if a very tight optical spectral occupancy of the signal is required by the system. On the other hand, in quadrature modulation, the OSNR performance of a DQPSK signal is degraded, as compared to that of a DPSK signal.

Hence techniques to enhance nonlinear tolerances and improve the OSNR performances of DQPSK systems are highly desirable.

Depending upon the embodiment, the present invention includes various features, which may be used. These features include the following:
1. Optical modulation system and method including an adaptive clock modulator and an optical signal modulator for enhanced nonlinear tolerance and improved OSNR performance;
2. Optical modulation system and method including a modified CSRZ clock modulator and a DQPSK modulator;
3. Method and apparatus for adaptive biasing in the modified CSRZ clock modulator for enhanced nonlinear tolerances and improved OSNR performances of DQPSK;
4. An adaptive method for fine tuning the power spectrum of an optical modulation system;
5. Method for biasing the clock pulse in the clock modulator such that the clock pulse drives through null but is not biased at either the null or the peak for carrier energy suppression;
6. Adaptive biasing method for the clock modulator using a optical spectral analyzer (OSA); and
7. Clock modulator, e.g. a pulse carver, having fixed biasing and adaptive clock amplitude setting for enhanced nonlinear tolerances and improved OSNR performance.

As shown, the above features may be in one or more of the embodiments to follow. These features are merely examples, which should not unduly limit the scope of the claims herein. One of ordinary skill in the art would recognize many variations, modifications, and alternatives.

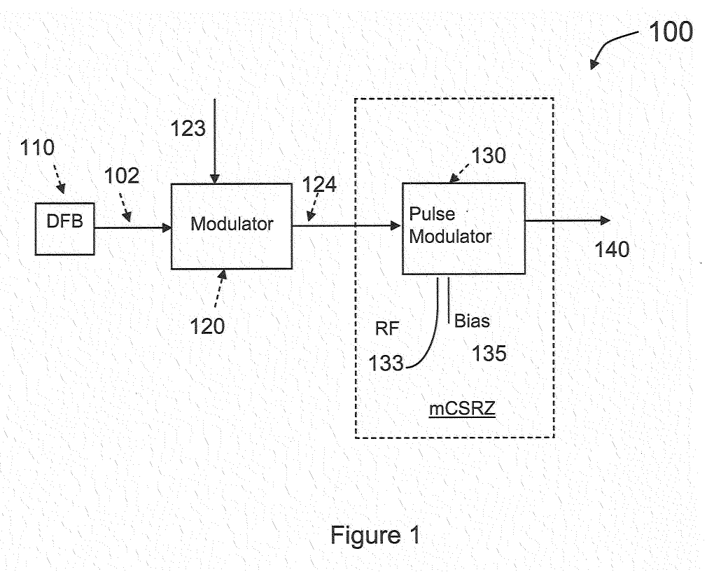

FIG. 1 is a simplified block diagram of an optical communication system according to an embodiment of the present invention. This diagram is merely an example, which should not unduly limit the scope of the claims herein. One of ordinary skill in the art would recognize other variations, modifications, and alternatives. As shown, communication system 100 includes an optical carrier signal source 110, such as a distributed feedback (DFB) laser, which produces an optical carrier signal 102. The system also includes an optical signal modulator 120 coupled to the optical carrier signal source. In a specific example, the modulator may include one or more phase modulators. The modulator also receives electrical signals 123. As an example, the electrical signal 123 may include digital data to be transmitted. The modulator 120 modulates the optical carrier signal to produce a continuous wave optical signal 124 in response to one or more input electrical signals 123. Furthermore, system 100 includes a pulse modulator 130 coupled to the modulator 120 to receive the continuous wave optical signal. The pulse modulator 130 adaptively modulates the continuous wave optical signal 124 to cause carrier energy suppression and nonlinearity reduction in the output optical signal 140.

In a specific embodiment, the pulse modulator 130 receives an electrical pulse signal 133. The electrical pulse signal is biased by a bias signal 135. The pulse modulator 130 modulates the continuous wave optical signal 124 in response to the electrical pulse signal 133. In a specific example, the electrical pulse signal is a radio frequency (RF) signal, e.g. at 20 GHz. The electrical pulse signal 133 is characterized by an amplitude and a bias point. In an embodiment, either the amplitude or the bias point is adaptively selected. Under these conditions, the pulse modulator 130 is capable of producing an On-Off-Keying (OOK) or Phase-Shift-Keying (PSK) optical signal that is characterized by enhanced carrier energy suppression and nonlinearity reduction. Further details of the optical communication system are illustrated in the examples below.

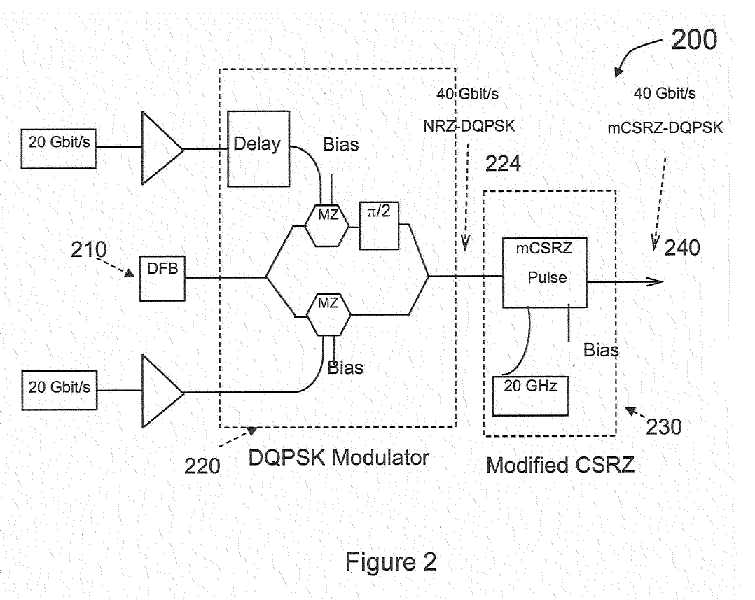

FIG. 2 is a simplified block diagram illustrating an optical transmission system according to a specific embodiment of the present invention. This diagram is merely an example, which should not unduly limit the scope of the claims herein. One of ordinary skill in the art would recognize other variations, modifications, and alternatives. As shown, FIG. 2 illustrates a Modified-Carrier-Suppressed Return-To-Zero Differential Quadrature Phase Shift Keying (mCSRZ-DQPSK) optical modulator 200. In this specific example, the transmitter 200 is capable of generating a 40 Gbit/s (2×20 Gbaud) capacity per wavelength. Of course, the technique can be applied for other data rates. Transmission system 200 includes a DFB laser 210, a DQPSK modulator 220, and a Modified-CSRZ (mCSRZ) pulse carver 230. The DQPSK modulator 220 shown in FIG. 2 is a dual-parallel DQPSK modulator. To generate 40 Gbit/s NRZ-DQPSK signals, two precoded 20 Gbit/s data streams are amplified to 2Vπ, appropriately delayed (for example, by ˜50 bit periods), and applied to each inner Mach-Zehnder (MZ) modulator of the dual-parallel DQPSK modulator. Here Vπ is defined as the switching voltage required to produce a π phase difference for the optical signals from the two arms of each inner Mach-Zehnder modulator. Each of the MZ in the dual-parallel DQPSK modulator is biased at null. A separate phase bias section gives the 90 degree phase shift required. When the two components (I- and Q-channel) are combined, a 40 Gbit/s NRZ-DQPSK signal 224 is formed.

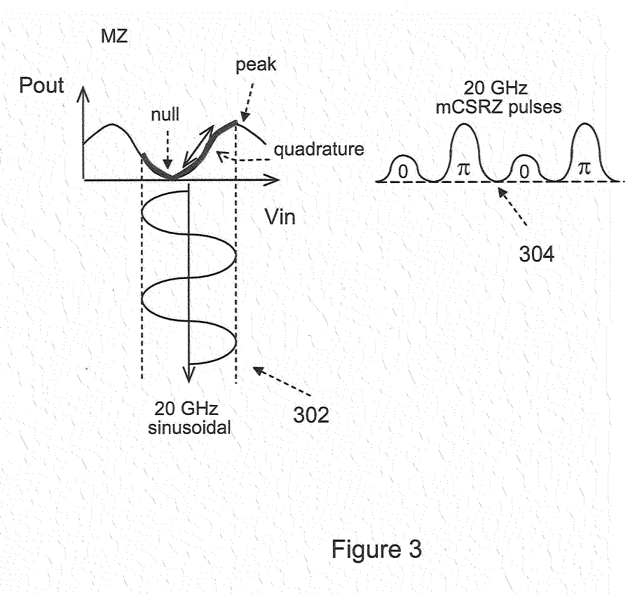

Next, the NRZ-DQPSK signal 224 is sent through the mCSRZ pulse carver 230. The mCSRZ pulse carver 230 modulates signal 224 and provide the output mCSRZ-DQPSK signal. According to a specific embodiment, the invention provides a method for enhanced carrier energy suppression and nonlinearity reduction. FIG. 3 is a simplified view diagram illustrating the method. Of course, this diagram is merely an example, which should not unduly limit the scope of the claims herein. One of ordinary skill in the art would recognize other variations, modifications, and alternatives. As shown, the output power (Pout) vs. input voltage (Vin) diagram in FIG. 3 illustrates an input-output characteristic of a modulator, such as an MZ modulator. A narrow-band sinusoidal clock signal 302 is used to drive a chirp-free MZ modulator, in such a way that the RF driving signal always goes through null. In contrast, in conventional methods of clock pulse generation, the RF drive does not go through null. As a result, because the RF driving signals pass null, a clock pulse with significant suppression of signal power at the carrier wavelength can be achieved. Such a clock pulse is defined here as a modified CSRZ (mCSRZ) pulse, in differentiating from a traditional CSRZ pulse. It is known that for traditional CSRZ, the amount of carrier suppression is fixed once a modulator is chosen. In contrast, according to embodiments of the invention, for mCSRZ, the amount of carrier suppression can be varied.

In various embodiments of mCSRZ-DQPSK, signal generation is achieved by the modulators that drive through null. Apart from null and maximum point of MZ, the bias points can be anywhere on the modulator characteristic curve such as shown in FIG. 3, including the quadrature bias point. In an embodiment, a non-quadrature biasing is used, and the amount of carrier suppression can be adjusted by shifting the bias point, corresponding to a constant RF driving voltage. In an alternative embodiment, the biasing is at quadrature. With the bias point fixed at quadrature, the carrier suppression can be adjusted by changing the RF driving power. According to embodiments of the invention, using the adaptive techniques discussed above, mCSRZ-DQPSK systems provide the capability to increase the suppression of signal power at carrier wavelength compared with conventional DQPSK techniques.

Other than the embodiment of FIG. 2, the techniques can be used with other types of DQPSK modulators, such as a dual-drive dual-parallel DQPSK modulator, a single dual-drive MZ modulator, and the case of two discrete MZ modulator used in series for NRZ-DQPSK data generation. Their use together with a mCSRZ pulse carver shall be considered within the scope of the present invention. Similarly, despite that the basic embodiment is given based on 20G baud rate as in FIG. 2, other baud rates can also be used.

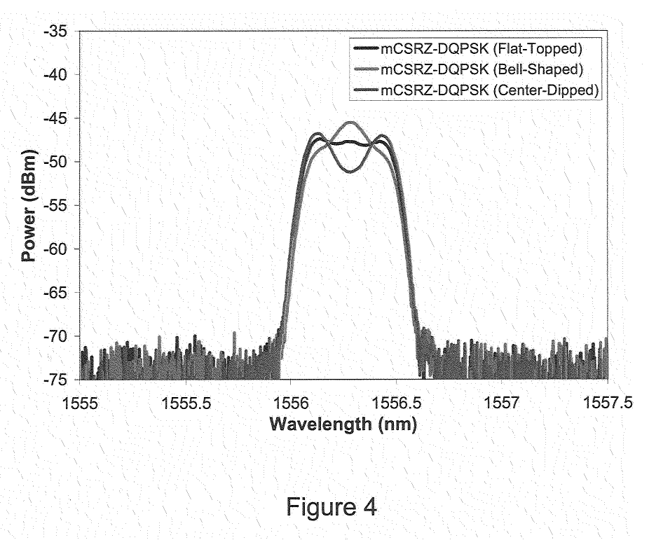

FIG. 4 is a simplified diagram showing the characteristic spectra of 40 Gbit/s (2×20 Gbaud) mCSRZ-DQPSK signals according to a specific embodiment of the present invention. The three mCSRZ-DQPSK variants correspond to different amounts of carrier suppression relative to RZ-DQPSK. They were obtained by using a RF driving voltage of ˜0.9Vπ. The Flat-topped mCSRZ-DQPSK had a bias point away from null by close to 17% of Vπ. The other two variants correspond to bias points of slightly over (Bell-shaped mCSRZ-DQPSK) or slightly under (Center-Dipped mCSRZ-DQPSK) that of the Flat-Topped mCSRZ-DQPSK. The spectral occupancies of the three variants within a 20 dB bandwidth are similar to each other, neglecting the differences in the peak structure.

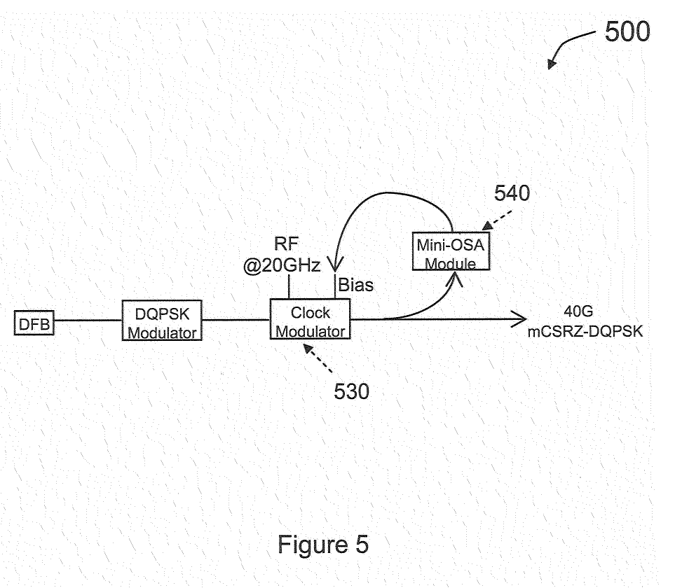

In system applications of mCSRZ-DQPSK, a stabilization of modulator bias is desirable. FIG. 5 shows a simplified block diagram of an mCSRZ-DQPSK optical system 500 according to another embodiment of the present invention. As shown, system 500 includes clock modulator 530. The optical spectra of mCSRZ-DQPSK signals from the clock modulator 530 is monitored through a mini-optical spectral analyzer (mini-OSA) module 540. The clock modulator 530 controls the bias point of the RF clock signal in response to the output of the spectral analyzer 540. By making use of a mini-OSA module, the signal spectrum can be monitored in real time. A drift in desired modulator bias will result in a change in the signal spectrum. This method can thus be used to actively control clock modulator bias drift. In an embodiment, arbitrary bias points can in principle be selected based on this approach.

According to a specific embodiment, the present invention provides a method for adaptively selecting a bias point for the clock modulator to enhance carrier energy suppression. The method can be briefly summarized below.
1. Select a starting bias point away from the null. For example, the bias point can be set at, e.g., 20% of Vπ above the null;
2. Monitor the spectrum using a spectrum monitor, such as a mini-OSA; and
3. Select a next bias point, to reduce the contribution from the carrier energy.
   This process can be used iteratively to determine the bias point adaptively.

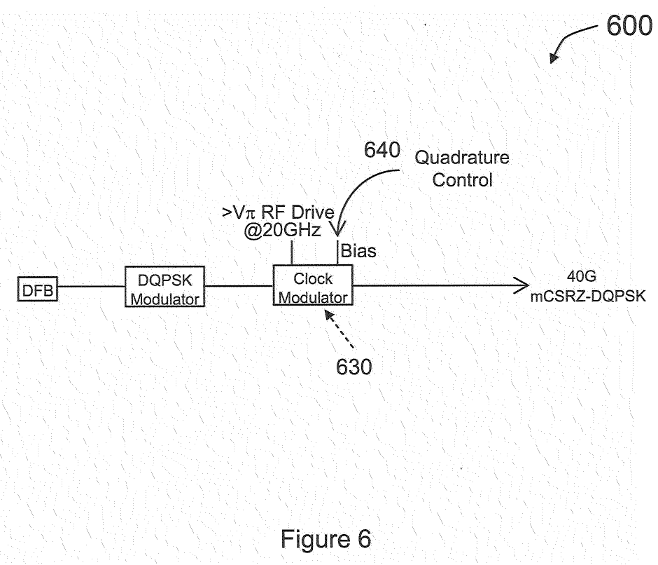

FIG. 6 shows a simplified block diagram of an mCSRZ-DQPSK optical system 600 according to an alternative embodiment of the present invention. In this embodiment, quadrature biasing is used for mCSRZ-DQPSK signal generation. In this case, the bias point can be fixed at quadrature, and the RF drive can go through modulator null if the driving voltage is more than Vπ and biased at quadrature. In this way, the enhanced carrier suppression characteristic typical of mCSRZ-DQPSK can be achieved by raising the levels of RF driving power while keeping the bias at quadrature. In a specific embodiment, the amplitude of the RF clock pulse signal can be increased to include the modulator null.

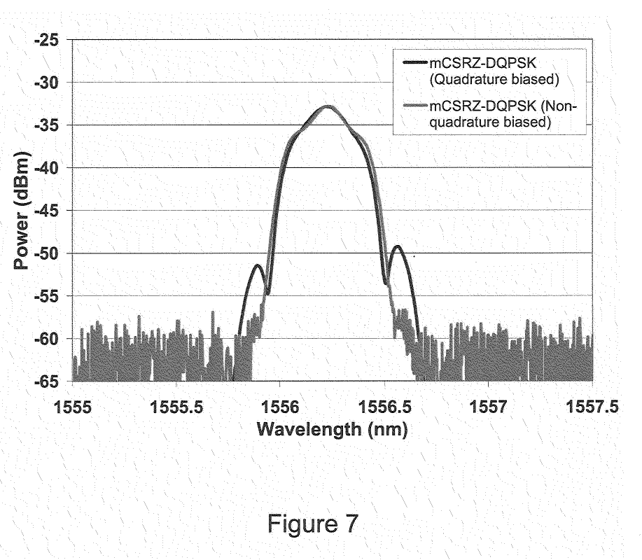

FIG. 7 is a simplified diagram comparing the spectrum of a quadrature-biased mCSRZ-DQPSK with that of a non-quadrature-biased mCSRZ-DQPSK. Here, for quadrature-biased mCSRZ-DQPSK, an RF driving power of ˜1.8Vπ is used. Within a 20 dB bandwidth, the spectral occupancy of the quadrature-biased mCSRZ-DQPSK is a good approximation to that of the non-quadrature-biased mCSRZ-DQPSK (in this case, the Bell-Shaped mCSRZ-DQPSK). The transmission characteristics of the two signals shown in FIG. 7 are found similar to each other, as transmission performance of a 40G modulation format is pre-dominantly determined by the spectral occupancy within its 20 dB spectral bandwidth. Therefore, based on this approach, quadrature bias control techniques can be used for mCSRZ-DQPSK. According to embodiments of the invention, with quadrature biasing, the amplitude of the RF clock pulse signal can be increased to include the modulator null, and enhanced carrier suppression can be achieved.

Although the systems in FIGS. 1-3 and 5-6 have been shown using a selected group of components for the improved nonlinearity tolerance and signal-to-noise reduction, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification and more particularly below.

According to an embodiment of the present invention, it provides a method for optical signal modulation. The method includes providing an optical carrier signal and modulating the optical carrier signal in response to one or more input electrical signals using one or more optical modulators to produce a continuous wave optical signal in response to one or more input electrical signals. The method also includes adaptively modulating the continuous wave optical signal to cause carrier energy suppression and nonlinearity reduction. In a specific embodiment, the method further includes providing an electrical pulse signal characterized by an amplitude and a bias point. At least one of the amplitude and the bias point is adaptively determined. In a specific embodiment, both the amplitude and the bias point are adaptively determined. Moreover, the method includes modulating the continuous wave optical signal in response to the electrical pulse signal to cause carrier energy suppression and nonlinearity reduction.

In a specific embodiment, the bias point of the electrical pulse signal is between a null point and a maximum point, but does not include the null point or the maximum point, of the continuous wave optical signal. In another embodiment, the amplitude of the electrical pulse signal is selected such that the electrical pulse signal drives the pulse modulator through the null point. In yet another embodiment, the electrical pulse signal is biased at a quadrature point and drives through the null point of the phase modulators to achieve enhanced carrier suppression.

The various bias conditions can lead to different output power spectrum characteristics. Some examples are shown in FIG. 4. In one example, the electrical pulse signal is biased at a non-quadrature point and has a predetermined amplitude, and an output optical signal is characterized by a flat top spectral profile. In another example, the electrical pulse signal is biased at a non-quadrature point and has a predetermined amplitude, and an output optical signal is characterized by a central dip spectral profile. In yet another example, the electrical pulse signal is biased at a non-quadrature point and has a predetermined amplitude, and an output optical signal is characterized by a broad bell-shaped spectral profile. In an embodiment, the method also includes maintaining modulator bias stabilization using an optical spectral monitor. In specific embodiments, the method can be implemented as illustrated in FIGS. 1-3 and FIG. 5.

In a specific embodiment, the one or more phase modulators include a first and a second phase modulators and produce an NRZ-DQPSK continuous wave optical signal, and the pulse modulator adaptively produces a mCSRZ-DQPSK. In another embodiment, the one or more phase modulators include a first and a second phase modulators and produce an NRZ-DQPSK continuous wave optical signal, and the pulse modulator adaptively produces a mCSRZ-DQPSK in response to an RF electrical pulse signal having a bias point at a quadrature point and an amplitude greater than Vπ, thereby causing enhanced carrier suppression by means of raising the RF power levels.

In an alternative embodiment, the invention provides another method for optical signal modulation. The method includes providing an optical carrier signal and modulating the optical carrier signal using a first and a second Mach-Zehnder modulators. The method also includes producing an NRZ-DQPSK optical signal in response to one or more input electrical signals, and then modulating the NRZ-DQPSK optical signal in response to an electrical pulse signal. The electrical pulse signal is biased at a shifted non-quadrature biasing point and has a predetermined amplitude. The non-quadrature biasing point is adaptively determined to cause carrier energy suppression and nonlinearity reduction. In a specific embodiment, the method also includes maintaining modulator bias stabilization using a mini optical spectral analyzer (OSA).

According to yet another embodiment, the invention provides a method for optical signal modulation. The method includes providing an optical carrier signal and modulating the optical carrier signal using a first and a second Mach-Zehnder modulators to produce an NRZ-DQPSK optical signal in response to one or more input electrical signals. Additionally, the method includes modulating the NRZ-DQPSK optical signal in response to a pulse signal. The pulse signal is biased at a shifted non-quadrature biasing point and has a predetermined amplitude. The predetermined amplitude is adaptively determined to cause carrier energy suppression and nonlinearity reduction. In a specific embodiment, the amplitude of the pulse signal is greater than Vπ of the Mach-Zehnder modulators.

The methods discussed above include sequences of processes that include adaptively biasing a pulse modulator to provide signals having enhanced nonlinearity tolerance and reduced distortion according to embodiments of the present invention. It is understood that other alternatives can also be provided where steps are added, one or more steps are removed, or one or more steps are provided in a different sequence without departing from the scope of the claims herein.

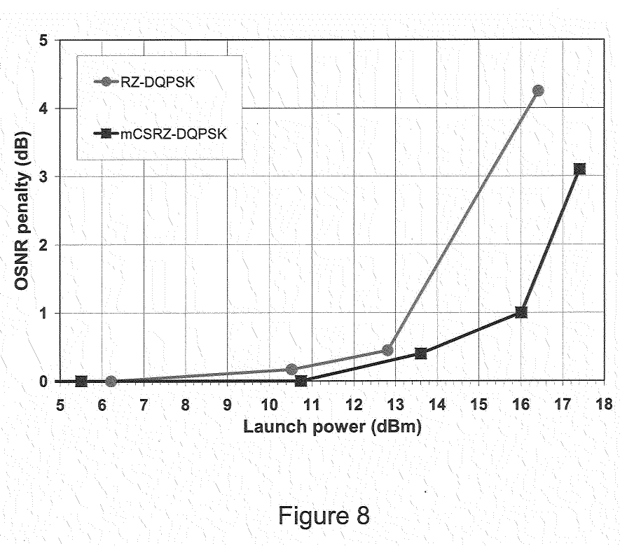

In order to evaluate the nonlinear tolerance performance, we performed experimental studies. The mCSRZ-DQPSK and conventional RZ-DQPSK signals were propagated through 20 km single mode fiber (SMF), followed by a dispersion compensating module (DCM) with a dispersion of −340 ps/nm. FIG. 8 shows the measured OSNR vs. launch power to SMF. Corresponding to a 1 dB OSNR penalty, mCSRZ-DQPSK signal showed a tolerance to as large as 2.7 dB higher launch power, compared with RZ-DQPSK. Hence the nonlinear tolerance enhancement capability of mCSRZ-DQPSK is confirmed.

In extensive transmission comparisons, mCSRZ-DQPSK exhibited unique performance advantages over conventional DQPSK modulation techniques. For example, an experimental investigation was carried out to compare the system performances of mCSRZ-DQPSK vs. RZ-DQPSK in a 1600 km (20×80 km) single mode fiber (SMF) system with two in-line optical equalization (OEQ) stations and EDFA-only amplifications. The two in-line OEQs had totally four 100 GHz wide arrayed waveguides (AWGs) and four 50 GHz-spaced interleavers (ITLs). In addition to the effect of gain equalization, these OEQs also caused strong optical filtering effects. Thus the system is also a good test of the resilience of DQPSK different formats to cascaded optical filtering.

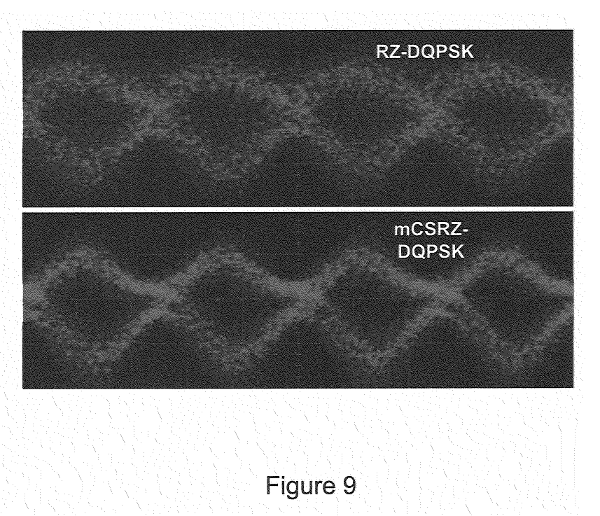

FIG. 9 shows the received eye diagrams after 1600 km transmission with a signal power of 4 dBm, comparing mCSRZ-DQPSK modulation format and conventional RZ-DQPSK modulation format. As a result of the strong nonlinear impacts from intra-channel cross phase modulation (XPM) impairments between I- and Q-channels, the eye diagram of RZ-DQPSK is very noisy, showing that the nonlinear tolerance of RZ-DQPSK is not sufficient in this case. In contrast, the eye diagrams of mCSRZ-DQPSK after transmission is widely open, thanks to its significantly enhanced nonlinear resilience.

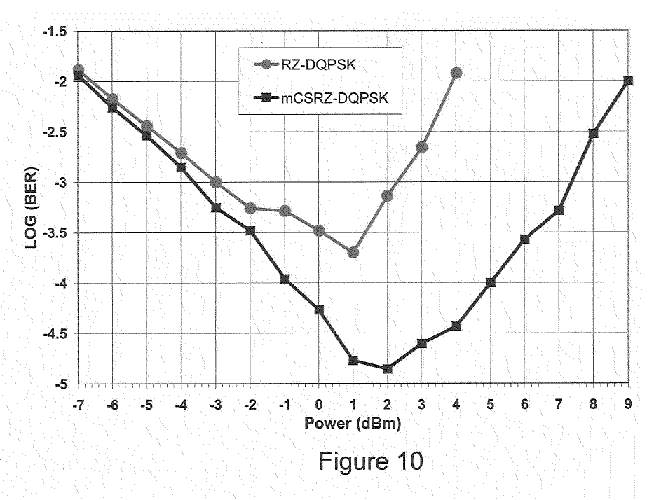

FIG. 10 is the measured BER vs. signal power for this comparative transmission. In the case of RZ-DQPSK, the optimum BER is 2e−4, achieved at 1 dBm; while for mCSRZ-DQPSK, the optimum BER is 1.4e−5, achieved at 2 dBm. Corresponding to a BER of 1e−3, the highest power allowed for RZ-DQPSK is 2.3 dBm, while for mCSRZ-DQPSK, the highest power allowed is 7.4 dBm. A significantly better tolerance, of as large as 5.1 dB, to high signal powers is demonstrated for mCSRZ-DQPSK. Thus, mCSRZ-DQPSK delivered significantly better BER performance and nonlinear tolerance, when compared with conventional RZ-DQPSK modulation technique, thanks to the unique mechanism of enhanced carrier suppression in mCSRZ-DQPSK.

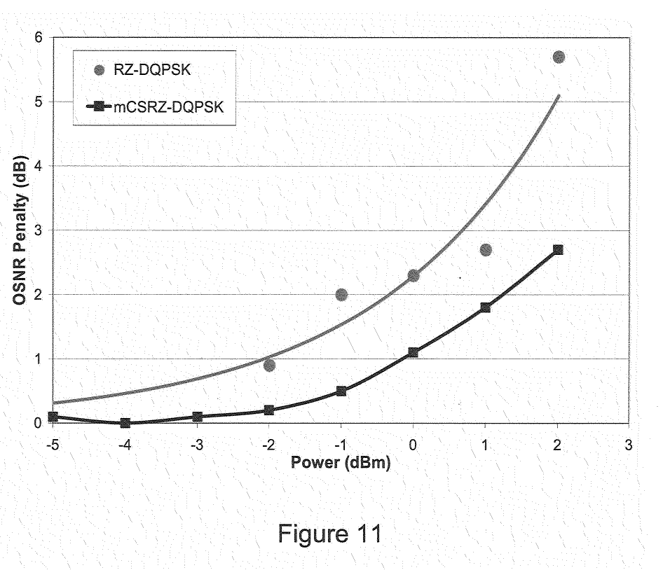

In another comparative transmission experiment, a 40G DQPSK signal and 11 OOK channels at 10G were mixed with 100 GHz spacing with the 40G DQPSK channel in the middle, and transmitted to over 1600 km, while dispersion per span is nearly completely compensated. Both RZ-DQPSK and mCSRZ-DQPSK were tested. The measured OSNR penalty after 1600 km transmission vs. signal power is shown in FIG. 11, comparing RZ-DQPSK and mCSRZ-DQPSK. The result indicates that for RZ-DQPSK, launch powers varying from −2 dBm to +2 dBm could be used to ensure the capability to achieve a BER of 1e−3, but incurred an OSNR penalty of 0.9 dB˜5.7 dB. In contrast, transmission over the same system could be achieved with mCSRZ-DQPSK with significantly reduced OSNR penalties. For example, at a signal power of −4 dBm, mCSRZ-DQPSK achieved the same transmission essentially without an OSNR penalty. On average, the OSNR performance of mCSRZ-DQPSK transmission was about 1˜3 dB better than that of RZ-DQPSK, as demonstrated in this comparative transmission.

The experimental results discussed above demonstrate the significant advantages of mCSRZ-DQPSK over conventional RZ-DQPSK modulation. Many benefits are achieved by way of the present invention over conventional techniques. For example, in an embodiment, the invention provides an optical modulation system and associated methods including an adaptive clock modulator and an optical signal modulator for enhanced nonlinear tolerance and improved OSNR performance. In a specific embodiment, the optical modulation system and method includes a modified CSRZ clock modulator and a DQPSK modulator. Additionally, in various embodiments of the invention, techniques are provided for adaptive modulation for improved nonlinear tolerance and improved OSNR performance.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. An optical communication system, comprising:
an optical carrier signal source that provides an optical carrier signal;
one or more optical modulators coupled to the optical carrier signal source, the one or more optical modulators modulating the optical carrier signal to produce a continuous wave optical signal in response to one or more input electrical signals, and
a pulse modulator coupled to the one or more phase modulators to receive the continuous wave optical signal, the pulse modulator being selectively configured to modulate the continuous wave optical signal to cause carrier energy suppression and nonlinearity reduction.

2. The system of claim 1 wherein the pulse modulator modulates the continuous wave optical signal in response to a pulse signal, the pulse signal having an amplitude and a bias point, at least one of the amplitude and the bias point being selected to cause carrier energy suppression and nonlinearity reduction.

3. The system of claim 2 wherein the bias point of the electrical pulse signal is between a null point and a maximum point, but does not include the null point or the maximum point, of the continuous wave optical signal.

4. The system of claim 2 wherein the amplitude of the electrical pulse signal is selected such that the electrical pulse signal drives the pulse modulator through the null point.

5. The system of claim 2 wherein the pulse signal is biased at a quadrature point and drives through the null point of the phase modulators to achieve enhanced carrier suppression.

6. The system of claim 2 wherein the pulse signal is biased at a non-quadrature point and has a predetermined amplitude, and an output optical signal is characterized by a flat top spectral profile.

7. The system of claim 2 wherein the pulse signal is biased at a non-quadrature point and has a predetermined amplitude, and an output optical signal is characterized by a central dip spectral profile.

8. The system of claim 2 wherein the pulse signal is biased at a non-quadrature point and has a predetermined amplitude, and an output optical signal is characterized by a broad bell-shaped spectral profile.

9. The system of claim 1 further comprising an optical spectral monitor for maintaining modulator bias stabilization.

10. The system of claim 1 wherein
the one or more phase modulators comprise a first and a second phase modulators and produce a Non-Return-to-Zero Differential Quadrature Phase Shift Keying (NRZ-DQPSK) continuous wave optical signal, and
the pulse modulator adaptively produces a modified Carrier Suppressed Return-to-Zero Differential Quadrature Phase Shift Keying (mCSRZ-DQPSK) signal.

11. The system of claim 1 wherein
the one or more phase modulators comprise a first and a second phase modulators and produce a Non-Return-to-Zero Differential Quadrature Phase Shift Keying (NRZ-DQPSK) signal continuous wave optical signal, and
the pulse modulator adaptively produces a modified Carrier Suppressed Return-to-Zero Differential Quadrature Phase Shift Keying (mCSRZ-DQPSK) signal in response to an RF electrical pulse signal having a bias point at a quadrature point and an amplitude greater than Vπ, thereby causing enhanced carrier suppression by means of raising the RF power levels.

12. An optical modulation system, comprising:
a laser that provides an optical carrier signal;
a first and a second Mach-Zehnder modulators coupled to the laser, the first and the second Mach-Zehnder modulators modulating the optical carrier signal to produce a Non-Return-to-Zero Differential Quadrature Phase Shift Keying (NRZ-DQPSK) optical signal in response to one or more input electrical signals, and
a pulse modulator coupled to the first and the second Mach-Zehnder modulators to receive the continuous wave optical signal, the pulse modulator adaptively modulating the NRZ-DQPSK optical signal in response to an electrical pulse signal, the electrical pulse signal being biased at a shifted non-quadrature biasing point and having a predetermined amplitude, the non-quadrature biasing point being adaptively determined to cause carrier energy suppression and nonlinearity reduction.

13. The system of claim 12 further comprising a mini optical spectral analyzer (OSA) for maintaining modulator bias stabilization.

14. An optical modulation system, comprising:
a laser that provides an optical carrier signal;
a first and a second Mach-Zehnder modulators coupled to the laser, the first and the second Mach-Zehnder modulators modulating the optical carrier signal to produce a Non-Return-to-Zero Differential Quadrature Phase Shift Keying (NRZ-DQPSK) optical signal in response to one or more input electrical signals, and
a pulse modulator coupled to the first and the second Mach-Zehnder modulators to receive the continuous wave optical signal, the pulse modulator adaptively modulating the Non-Return-to-Zero Differential Quadrature Phase Shift Keying (NRZ-DQPSK) optical signal in response to an RF electrical pulse signal, the electrical pulse signal being biased at a quadrature biasing point and having an amplitude greater than Vπ of the Mach-Zehnder modulators, the amplitude being adaptively determined to cause carrier energy suppression and nonlinearity reduction.

15. A method for optical signal modulation, comprising:
providing an optical carrier signal;
modulating the optical carrier signal using one or more phase modulators;
producing a continuous wave optical signal in response to one or more input electrical signals, and
adaptively modulating the continuous wave optical signal to cause carrier energy suppression and nonlinearity reduction.

16. The method of claim 15 further comprising:
providing an electrical pulse signal characterized by an amplitude and a bias point;
adaptively determining at least one of the amplitude and the bias point; and
modulating the continuous wave optical signal in response to the electrical pulse signal to cause carrier energy suppression and nonlinearity reduction.

17. The method of claim 16 wherein the bias point of the electrical pulse signal is between a null point and a maximum point, but does not include the null point or the maximum point, of the continuous wave optical signal.

18. The method of claim 16 wherein the amplitude of the electrical pulse signal is selected such that the electrical pulse signal drives the pulse modulator through the null point.

19. The method of claim 16 wherein the electrical pulse signal is biased at a quadrature point and drives through the null point of the phase modulators to achieve enhanced carrier suppression.

20. The method of claim 16 wherein the electrical pulse signal is biased at a non-quadrature point and has a predetermined amplitude, and an output optical signal is characterized by a flat top spectral profile.

21. The method of claim 16 wherein the electrical pulse signal is biased at a non-quadrature point and has a predetermined amplitude, and an output optical signal is characterized by a central dip spectral profile.

22. The method of claim 16 wherein the electrical pulse signal is biased at a non-quadrature point and has a predetermined amplitude, and an output optical signal is characterized by a broad bell-shaped spectral profile.

23. The method of claim 15 further comprising maintaining modulator bias stabilization using an optical spectral monitor.

24. The method of claim 15 wherein
the one or more phase modulators comprise a first and a second phase modulators and produce an Non-Return-to-Zero Differential Quadrature Phase Shift Keying (NRZ-DQPSK) continuous wave optical signal, and
the pulse modulator adaptively produces a modified Carrier Suppressed Return-to-Zero Differential Quadrature Phase Shift Keying (mCSRZ-DQPSK) signal.

25. The method of claim 15 wherein
the one or more phase modulators comprise a first and a second phase modulators and produce an Non-Return-to-Zero Differential Quadrature Phase Shift Keying (NRZ-DQPSK) continuous wave optical signal, and
the pulse modulator adaptively produces a Carrier Suppressed Return-to-Zero Differential Quadrature Phase Shift Keying (mCSRZ-DQPSK) signal in response to an RF electrical pulse signal having a bias point at a quadrature point and an amplitude greater than Vπ, thereby causing enhanced carrier suppression by means of raising the RF power levels.

26. A method for optical transmission, comprising:
providing an optical carrier signal;
modulating the optical carrier signal using a first and a second Mach-Zehnder modulators;
producing a Non-Return-to-Zero Differential Quadrature Phase Shift Keying (NRZ-DQPSK) optical signal in response to one or more input electrical signals,
modulating the NRZ-DQPSK optical signal in response to a pulse signal, the pulse signal being biased at a shifted non-quadrature biasing point and having a predetermined amplitude, the non-quadrature biasing point being adaptively determined to cause carrier energy suppression and nonlinearity reduction.

27. The method of claim 26 further comprising maintaining modulator bias stabilization using a mini optical spectral analyzer (OSA).

28. A method for optical transmission, comprising:
providing an optical carrier signal;
modulating the optical carrier signal using a first and a second Mach-Zehnder modulators;
producing a Non-Return-to-Zero Differential Quadrature Phase Shift Keying (NRZ-DQPSK) optical signal in response to one or more input electrical signals; and
modulating the NRZ-DQPSK optical signal in response to a pulse signal, the pulse being biased at a shifted non-quadrature biasing point and having a predetermined amplitude; the predetermined amplitude being adaptively determined to cause carrier energy suppression and nonlinearity reduction.

29. The method of claim 28 wherein the amplitude of the pulse signal is greater than Vπ of the Mach-Zehnder modulators.
